(19) United States
(12) Patent Application Publication
(10) Pub. No.: US 2014/0013212 A1
(43) Pub. Date: Jan. 9, 2014

(54) DYNAMIC TEMPLATE GALLERIES

(71) Applicants: Kyle Von Haden, Mill Creek, WA (US); Ryan P. Heaney, Seattle, WA (US); Emily J. Greenberg, Redmond, WA (US)

(72) Inventors: Kyle Von Haden, Mill Creek, WA (US); Ryan P. Heaney, Seattle, WA (US); Emily J. Greenberg, Redmond, WA (US)

(73) Assignee: MICROSOFT CORPORATION, Redmond, WA (US)

(21) Appl. No.: 13/541,861

(22) Filed: Jul. 5, 2012

(51) Int. Cl. G06F 17/00

(52) U.S. Cl. 715/243

(57) ABSTRACT

Provided herein are systems, methods, and software for facilitating templates within productivity applications. Upon launching a productivity application, a template gallery is rendered within the productivity application. Within the template gallery graphical representations of several templates are also rendered, including a graphical representation of a blank template, a graphical representation of a roaming template, and a graphical representation of a suggested template.

### TECHNICAL FIELD

Aspects of the disclosure are related to computer hardware and software technologies and in particular templates rendered within productivity applications.

### TECHNICAL BACKGROUND

Content templates are provided by many software applications as a way for users to quickly create content based on common style or formatting configurations. For example, many document editor applications provide templates for creating common types of documents, such as invoices, invitations, letters, and resumes. Indeed, templates can be found in a variety of applications beyond document editors, such as spreadsheet, presentation, email, and illustration applications.

Templates are generally accessed by navigating an application menu to create a new content item, such as a document, spreadsheet, presentation, or the like. Upon reaching a template menu, icons representative of various templates can be displayed. By clicking on a template icon, a document created from an associated template may share many of the style and formatting characteristics of the template. While many applications provide pre-loaded templates, original templates can also be created and saved for later use.

A variety of application environments may employ templates. Productivity applications, and their associated templates, may be provided on a variety of computing devices, such as desktop computers, laptop computers, tablet computers, mobile phones, and smart phones. In fact, the applications themselves may be provisioned in a variety of ways, such in a locally executed, hosted, or streaming manner. Templates can be accessed by way of any of the aforementioned platforms and delivery technologies.

### Overview

Provided herein are systems, methods, and software for facilitating templates within productivity applications. In an implementation, upon launching a productivity application, a template gallery is rendered within the productivity application. Within the template gallery graphical representations of several templates are also rendered, including a graphical representation of a blank template, a graphical representation of a roaming template, and a graphical representation of a suggested template.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an application view in an implementation.

FIG. 2 illustrates a template rendering process in an implementation.

FIG. 3 illustrates a computing system in an implementation.

FIG. 4A illustrates an application view in an implementation.

FIG. 4B illustrates an application view in an implementation.

FIG. 5A illustrates an application view in an implementation.

FIG. 5B illustrates an application view in an implementation.

FIG. 6A illustrates an application view in an implementation.

FIG. 6B illustrates an application view in an implementation.

FIG. 7A illustrates an application view in an implementation.

FIG. 7B illustrates an application view in an implementation.

FIG. 8 illustrates a screen shot in an implementation.

FIG. 9 illustrates a screen shot in an implementation.

FIG. 10 illustrates a screen shot in an implementation.

FIG. 11 illustrates a screen shot in an implementation.

### TECHNICAL DISCLOSURE

Implementations described herein provide for improved productivity applications having enhanced template capabilities. In particular, the productivity applications render dynamic template galleries having a variety of useful templates included therein. Rendering a template gallery upon initiating an application allows for quick access to and enjoyment of templates, among other benefits. Other optional features may be included in the template gallery, such as a search tool and a filter tool.

The templates may include, for example, a blank template, a roaming template, and a suggested template, as well as other kinds of templates. The initial screen displayed upon launching the application may include not just the template gallery, but possibly other elements, such as a list of most recently used documents or other content items. Thus, the initial screen available for viewing allows the user to access templates or most recently used documents without undue navigation.

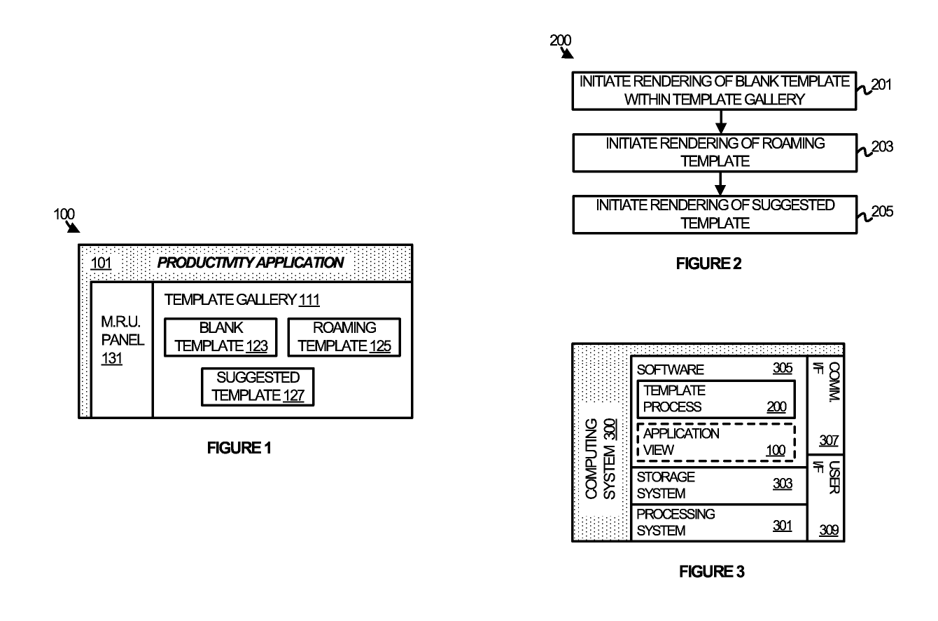

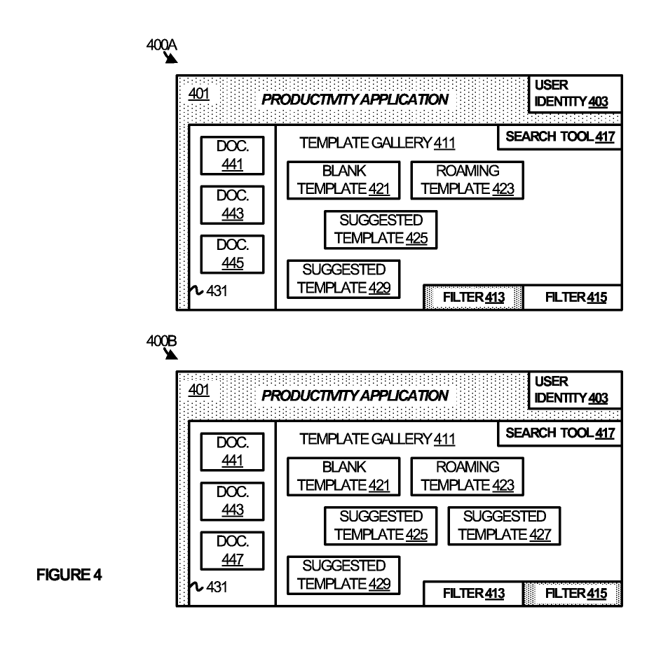

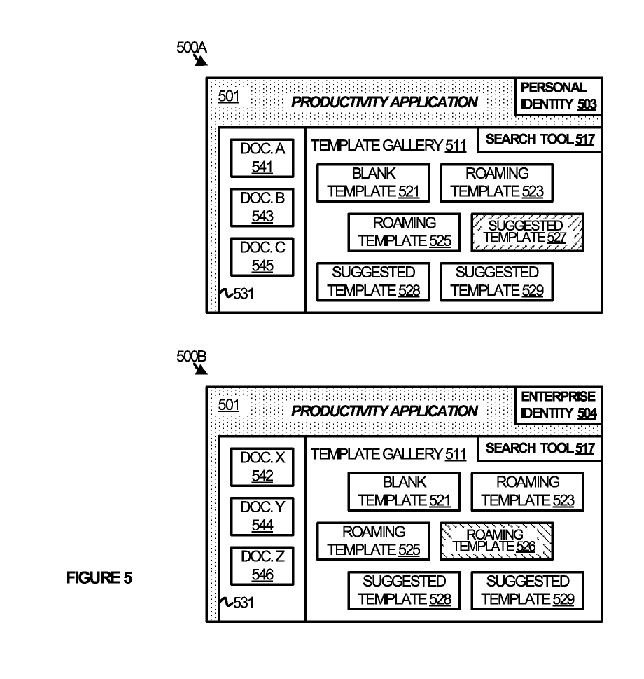

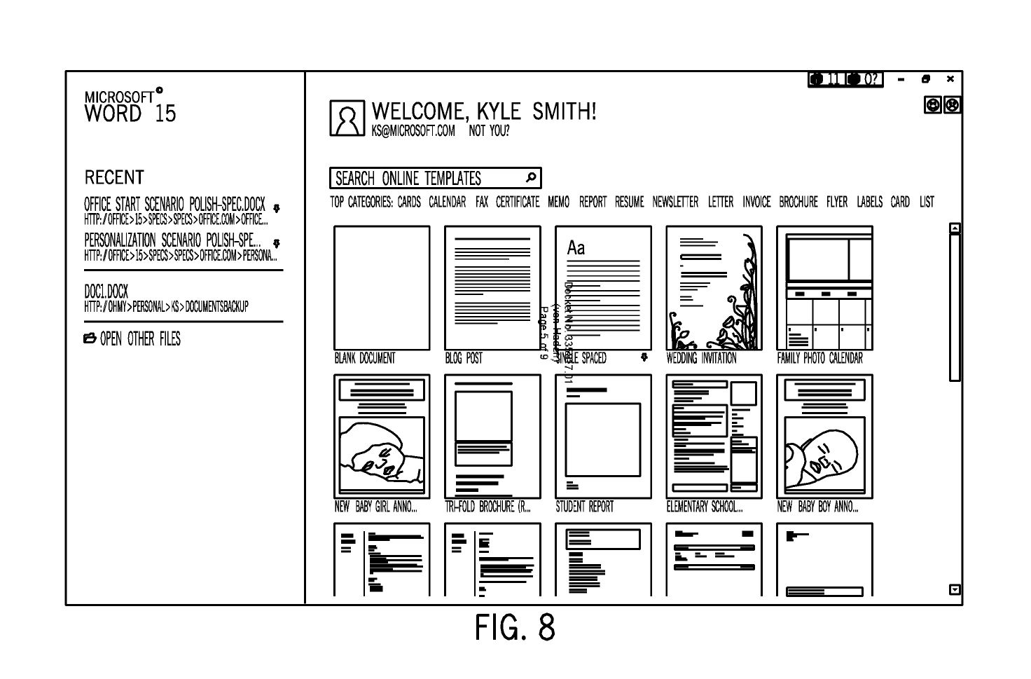

Referring to the drawings, FIG. 1 illustrates an application view, while FIG. 2 illustrates a rendering process related to the application view. FIG. 3 illustrates a computing system for executing the process or method within the context of the application view. FIGS. 4-7 illustrate several more application views, while FIGS. 8-11 illustrate several screen shots.

FIG. 1 illustrates application view 100. Application view 100 includes application title 101, template gallery 111, and most recently used (MRU) panel 131. MRU panel 131 is optional. Displayed within template gallery 111 are graphical representations of a blank template 123, a roaming template 125, and a suggested template 127, referred to herein as simply blank template 123, roaming template 125, and suggested template 127 for purposes of clarity. Blank template 123, roaming template 125, and suggested template 127 may comprise a personal selection or group of templates associated with a user from which new files can be created. It may be appreciated that other templates are possible but are not shown for purposes of clarity.

Application view 100 may be any view produced by a productivity application executing on a computing device. Examples of computing devices include tablet, notebook, laptop, and desktop computers, mobile phones, smart phones, personal digital assistants, gaming devices, server computers, virtual machines, and Internet appliances, as well as any variation or combination thereof. Application title 101 is representative of any area within application view 100 that identifies the application. In this illustration, the application is entitle productivity application, merely for exemplary purposes. Application title 101 is merely optional and need not be included in application view 100.

Most recently used panel 131 is also optional and need not be included in application view 100. Icons or other graphical representations of documents or other content items may be identified or otherwise included in most recently used panel 131. A user operating a user interface may click on, touch, select, or otherwise invoke any of the content items, thereby launching the items within the productivity application.

Blank template 123 may be any template representative of a basic or baseline configuration. An example is a graphical representation of a blank productivity item, such as a document icon or a spreadsheet icon. The icon may itself comprise an image or graphic corresponding to a productivity item. Upon clicking, touching, or otherwise invoking blank template 123, a new content item, such as a document, spreadsheet, presentation, or the like, is rendered to the user. Blank template 123 may sometimes be the first template in template gallery 111 and is generally not removable by user action, although it could possibly be removed by administrator action or by group policy. Blank templates are generally provided automatically as part of a standard package of templates installed with an application.

Roaming template 125 may be any template designated by the user or some other entity to roam with the user. Roaming templates may be considered favorites. For example, a user may pin or otherwise designate a sample template provided by the productivity application as a favorite, such that a graphical representation of a pin is rendered and displayed along with the graphical representation of the template. In another example, the favorites may be pre-designated or pre-selected as a set of templates that roam with the user. Roaming may be considered the capability for the user identified to various instances of a productivity application such that custom or designated templates follow the user. For instance, should the user create a template while using one device, but then engage with the same productivity application or suite of applications while using another, different device, the same template will be available. Roaming template 123 may be an original template created by the user, a favorite template designated for roaming by the user, or any other kind of template capable of being roamed.

Suggested template 129 may be any template suggested to the user, possibly in an automatic fashion by the productivity application. Suggested templates may also be considered featured templates. For example, a set of templates may be suggested or featured based on the user's identity. While some templates may be presented to the user when engaged under a personal identity, other templates may be presented to the user when engaged under an enterprise identity. The featured templates can be determined dynamically by the productivity application, but may also be programmed and controlled remotely. For example, an administrator may specify which templates should be featured for which people within an enterprise. Upon logging into an application, that set of templates could then be rendered and displayed within a template gallery. In another example, templates may be suggested based on past user behavior with respect to the productivity application. Alternatively, templates may be suggested based on the user's behavior with other applications, such as his or her web browsing history. In yet another example, templates may be suggested based on what other applications were recently used. An invoice template may be suggested in view of a user's recent activity with a financial application. A wide variety of template suggestions are possible and should not be limited to just those disclosed herein.

FIG. 2 illustrates template rendering process 200, a discussion of which will proceed with reference to FIG. 1. To begin, rendering of blank template 123 within template gallery 111 (step 201) is initiated. For example, a blank template icon may be generated for display. Rendering blank template 123 may occur in response to launching the productivity application. Optionally, blank template 123 may be rendered upon invocation of a new item command. Simultaneously with rendering blank template 123, or nearly simultaneously, rendering of roaming template 125 within template gallery 111 (step 203) is initiated. Finally, rendering of suggested template 127 is initiated nearly simultaneously with the rendering of blank template 123 and roaming template 125 (step 205).

Other steps or functionality may optionally be performed with respect to template rendering process 200. An identifying step may be performed in order to identify which templates are to be rendered and displayed within template gallery 111. While blank template 123 may be a default template that is rendered in most cases, roaming template 125 and suggested template 127 may be identified based on a variety of factors, such as those discussed above with respect to the user's identity. Thus, roaming template 125 may be identified or selected from among many possible templates and may be indicated in configuration or profile settings associated with the user. Similarly, suggested template 127 may be identified or selected from among many possible templates.

While application view 100 illustrates three templates within template gallery 111, it may be appreciated that additional templates are possible. Additional roaming templates and additional suggested templates may be rendered and displayed within template gallery 111. Other kinds of templates may also be included within template gallery 111 or other distinctions may be made between templates, such as those associated with a personal identity and those associated with an enterprise identity.

The productivity application may include the functionality of initiating the rendering of each object. Alternatively, another application program or an operating system element may perform the step of initiating the rendering. In addition, the actual rendering of images for display may be performed by the productivity application, but may also be functionality contained in another application or operating system component. The actual display of the templates is generally carried out by user interface elements, such as a display screen driven by various display components, such as a graphics processor.

Referring now to FIG. 3, a computing system suitable for implementing a template rendering process is illustrated. Computing system 300 is generally representative of any computing system or systems on which template rendering process 200 may be suitably implemented. Optionally, computing system 300 may also be suitable for implementing application view 100. Examples of computing system 300 include server computers, client computers, virtual machines, distributed computing systems, personal computers, mobile computers, media devices, Internet appliances, desktop computers, laptop computers, tablet computers, notebook computers, mobile phones, smart phones, gaming devices, and personal digital assistants, as well as any combination or variation thereof.

Computing system 300 includes processing system 301, storage system 303, software 305, communication interface 307, and user interface 309. Note that some elements may be omitted in various scenarios. Processing system 301 is operatively coupled with storage system 303, communication interface 307, and user interface 309. Processing system 301 loads and executes software 305 from storage system 303. When executed by computing system 300 in general, and processing system 301 in particular, software 305 directs computing system 300 to operate as described herein for template rendering process 200. Computing system 300 may optionally include additional devices, features, or functionality not discussed here for purposes of brevity and clarity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations of processing devices, or variations thereof.

Storage system 303 may comprise any storage media readable by processing system 301 and capable of storing software 305. Storage system 303 may include volatile and nonvolatile, removable and non-removable media implemented in any method or technology for storage of information, such as computer readable instructions, data structures, program modules, or other data. Storage system 303 may be implemented as a single storage device but may also be implemented across multiple storage devices or sub-systems. Storage system 303 may comprise additional elements, such as a controller, capable of communicating with processing system 301.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software 305 may be implemented in program instructions and among other functions may, when executed by computing system 300, direct computing system 300 to render a template gallery upon initiating the productivity application and render within the template gallery a graphical representation of a blank template, a graphical representation of a roaming template, and a graphical representation of a suggested template. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform processing system 301, and computing system 300 overall, from a general-purpose computing system into a special-purpose computing system customized to facilitate a template gallery as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage.

For example, if the computer-storage media are implemented as semiconductor-based memory, software 305 may transform the physical state of the semiconductor memory when the program is encoded therein. For example, software 305 may transform the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 300 is generally intended to represent a computing system with which software 305 is deployed and executed in order to implement template rendering process 200 and optionally render application view 100. However, computing system 300 may also represent any computing system on which software 305 may be staged and from where software 305 may be distributed, transported, downloaded, or otherwise provided to yet another computing system for deployment and execution, or yet additional distribution.

Referring again to FIG. 1, through the operation of computing system 300 employing software 305, transformations may be performed with respect to application view 100. As an example, computing system 300 could be considered transformed from one state to another when subject to template rendering process 200. In a first state, template gallery 111 is not rendered. Upon initiating the productivity application, template gallery 111 is rendered, along with blank template 123, roaming template 125, and suggested template 127, thereby changing computing system 300 to a second, different state.

Referring again to FIG. 3, communication interface 307 may include communication connections and devices that allow for communication between computing system 300 other computing systems not shown over a communication network or collection of networks. Examples of connections and devices that together allow for inter-system communication include network interface cards, antennas, power amplifiers, RF circuitry, transceivers, and other communication circuitry. The aforementioned network, connections, and devices are well known and need not be discussed at length here.

User interface 309 may include a mouse, a voice input device, a touch input device for receiving a gesture from a user, a motion input device for detecting non-touch gestures and other motions by a user, and other comparable input devices and associated processing elements capable of receiving user input from a user. Output devices such as a display, speakers, printer, haptic devices, and other types of output devices may also be included in user interface 309. The aforementioned user input devices are well known in the art and need not be discussed at length here.

FIG. 4 illustrates application view 400A and application view 400B. Application view 400A is any view that may be produced by a productivity application, such as an introductory or splash screen, generated and displayed in response to launching the productivity application. In other words, application view 400A may be considered a start screen. It may be possible to navigate back to the start screen when using the productivity application. In addition, it may be possible to navigate to a similar screen, menu arrangement, or presentation of a template gallery through other menus. For example, navigating a menu to generate a new productivity item may result in presentation of a similar, if not the same, view. It should be understood that application view 400B and application view 400B are presented merely for exemplary purposes to demonstrate filter functionality that may be included within a template gallery. Which templates are displayed within a template gallery may depend upon which template filter is engaged. Application view 400A presents a scenario where one filter is engaged, while application view 400B illustrates a second scenario where another, different filter is engaged.

Application view 400A includes application title 401, user identity 403, template gallery 411, and most recently used (MRU) panel 431. Template gallery 411 includes blank template 421, roaming template 423, suggested template 425, and suggested template 429. MRU panel 431 includes a list of most recently used productivity items, such as documents, spreadsheets, presentations, and the like, including document graphic 441, document graphic 443, and document graphic 445. The list of most recently used productivity items need not be presented using graphics. Rather, a text-based list or other suitable display format may be implemented.

Templates within template gallery 411 may be filtered by way of graphical representations of filter 413 and filter 415, herein referred to simply as filter 413 and filter 415. The functionality of filter 413 and filter 415 is illustrated by way of application view 400B. Filter 415 is selected in application view 400B, in contrast with application view 400A where filter 413 is selected. Suggested template 427 is present in application view 400B, while absent from application view 400A, representing the results of filters 413 and 415. In other words, suggested template 427 has been filtered from template gallery 411 by the application of filter 413, but included by application of filter 415.

Filter 413 and filter 415 may both be capable of filtering templates based on a variety of criteria. For example, templates may be filtered based on their author's identity. In one implementation, filter 413 may filter out templates created by the user, while filter 415 may include templates created by the user. In another example, templates may be filtered based on organization or enterprise associations. In one implementation, filter 413 may filter out templates associated with one enterprise, while filter 415 may include templates associated with the enterprise. In a variation, filter 413 may include templates associated with just one enterprise or organization, while filter 415 may include templates associated with a different enterprise or organization. It should be understood that a wide variety of template filters may be considered and applied without departing from teachings herein.

In yet another variation, a third or more additional filters or tabs may be provided allowing the user to distinguish templates with increasing granularity. For example, the user may custom-define a filter based on keywords. In an implementation, a filter may be set to render just those templates relating to resumes, for example. In another example, a filter may be set to render just those templates relating to invoices. The user may be able to add and remove filters, and define and redefine filters, dynamically. In addition to roaming various templates, filters may also be roamed such that the same filters are available to the user within a template gallery regardless of with which device the user is engaged.

FIG. 5 illustrates application view 500A and application view 500B to demonstrate how templates selected for inclusion within a template gallery may vary based on user identity. In application view 500A, a user is logged into a productivity application under a personal identity, while in application view 500B, the user is logged in under an enterprise identity. Thus, possible variation may occur with respect to the roaming and suggested templates selected or otherwise identified for rendering within a template gallery.

Application view 500A includes application title 501, template gallery 511, and most recently used (MRU) panel 531. Template gallery 511 includes blank template 521, roaming template 523, roaming template 525, suggested template 527, suggested template 528, and suggested template 529. MRU panel 531 includes document A 541, document B 543, and document C 545. Search tool 517 may be used to search templates within template gallery 511, or optionally other template stores, such as an online template gallery. Note the application view 500A may include other optional features, such as filter tabs.

Application view 500A also includes personal identity 503, representative of a personal identity with which a user may login to the productivity application. In contrast, application view 500B includes enterprise identity 504. Enterprise identity 504 is representative of an enterprise identity with which the same user may login to the productivity application. Note that application view 500B also includes a different set of templates than those found in application view 500A. Namely, application view 500B includes roaming template 526 in place of suggested template 527. In addition, application view 500B includes a different set of documents within MRU panel 531. Namely, MRU panel 531 includes document X 542, document Y 544, and document Z 546.

The templates and documents found in application view 500B may differ from those found in application view 500A for a variety of reasons. For example, the user may pin different templates, designating them for roaming status, when logged in under his or her personal identity than when logged in under an enterprise identity. The templates pinned under a personal identity may be more personal in nature, such as a greeting card or resume template. In contrast, the templates pinned under an enterprise identity may be more enterprise-related, such as an invoice template.

Search tool 517 may be used to search for templates having a file format or type that is in accordance with the productivity application. For instance, assuming the productivity application is a document editor, search tool 517 may search for templates having a document format. Similarly, a spreadsheet application may include a search tool that searches for templates having a spreadsheet format. However, search tool 517 may also be capable of searching for and returning template results having varying formats. For example, assuming search tool 517 is deployed within a document editor, it may be possible to search not only for template documents, but also template spreadsheets and template presentations. In other words, search tool 517 may be capable of searching for any template type, such as templates configured according to a database format, a drawing format, a presentation format, an email format, an image format, and a spreadsheet format, as well as a document format or any other kind of file format. In some cases, search tool 517 may be capable of searching only for template types supported by the underlying computer. In other words, only template types for installed or otherwise available applications will be returned. For example, if the computer being searched by search tool 517 includes a document editor and a spreadsheet application installed thereon, but not a drawing program, then document templates and spreadsheet templates may be returned by search tool 517, but not drawing templates.

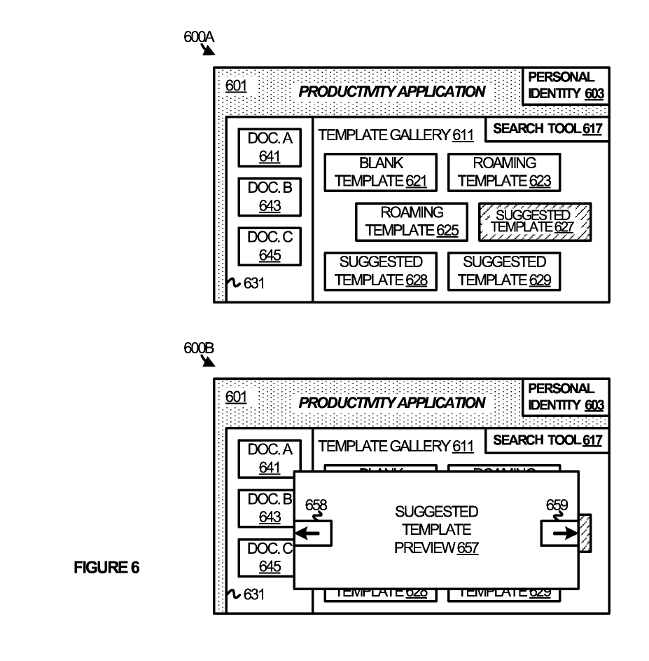

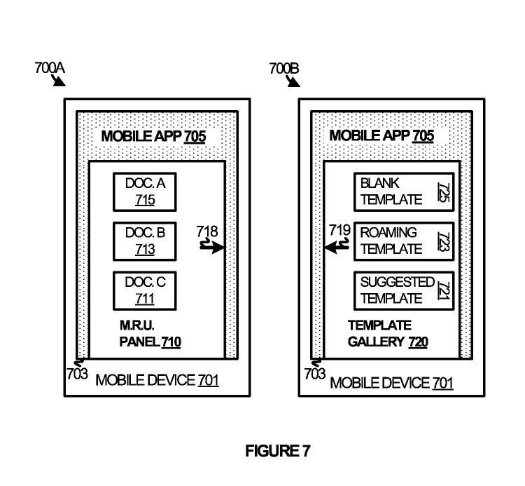

FIG. 6 illustrates application view 600A and application view 600B. Application view 600A is representative of various elements rendered by a productivity application, including various templates. Application view 600B is representative of a preview of one template selected from application view 600A.

In particular, application view 600A includes application title 601, template gallery 611, and most recently used (MRU) panel 631. Template gallery 611 includes blank template 621, roaming template 623, roaming template 625, suggested template 627, suggested template 628, and suggested template 629. MRU panel 631 includes document A 641, document B 643, and document C 645. Search tool 617 may be used to search templates within template gallery 611, or optionally other template stores, such as an online template gallery. Any of the templates within template gallery 611 are selectable to preview.

It is assumed for illustrative purposes that suggested template 627 is selected. Thus, in application view 600B, a preview of suggested template 627, suggested template preview 657, is displayed in a manner laid over template gallery 611 and MRU panel 631. Suggested template preview 657 includes navigation tool 658 and navigation tool 659. Navigation tool 658 allows a user to navigate from one preview to another. Upon selecting navigation tool 658, for example, a preview of roaming template 625 may be rendered. Upon selecting navigation tool 659, for example, a preview of suggested template 628 may be rendered. It should be understood that a variety of sequences or order through which templates may be previewed is possible and is not limited to the sequence disclosed herein.

Suggested template preview 657 may include a wide variety of information to aid the user in deciding upon a template for generating a new document or content item. A title, description, rating, and size of the template are examples of information that may be included in suggested template preview 657. For example, a rating indicating a popularity of the template across a group of users or recipients may be provided within the information. The author of the template may be identified, possibly allowing the user to contact the author. Other kinds of information are possible and should not be limited to just that information presented herein.

Suggested template preview 657 may also present or otherwise provide some configuration tools, such as color, font, or style tools, allowing the user to manipulate the template within the preview screen. In one implementation, the user may alter a background color or object color within the template preview screen. In another implementation, the user may alter a font style or some other formatting setting. In this manner, the user may adjust the template during the preview stage, allowing the user to preview the modifications, rather than having to create a new document and then test the modifications. The modifications may be saved to the template. Alternatively, the modifications may be saved as a new, custom template directly from the preview screen. The template being previewed can be pinned from the preview screen and added to a list of favorite or roaming templates. In yet another variation, a gallery of variations to the template being previewed can be accessed. The gallery may be navigated to from within the preview screen or may be external or otherwise separate from the preview screen. Of course, a new document may be generated directly from the preview screen. For example, the user may click a create button that launches a new document formatted and styled according to the template being previewed.

FIG. 7 illustrates mobile application view 700A and mobile application view 700B. Mobile application view 700A depicts mobile application 705 in one state whereby a most recently used (MRU) panel 710 is displayed. MRU panel 710 includes document A icon 715, document B icon 713, and document C icon 711. Mobile application 705, including MRU panel 710 and any other screens, views, or graphics, is displayed on screen 703. Mobile application view 700B depicts mobile application 705 in another state whereby template gallery 720 is visible.

Due to the generally limited screen size of some mobile devices, it may not be possible to display a template gallery simultaneously with MRU panel 710. Navigation tool 718 is provided to allow a user to navigate to from MRU panel 710, or some other screen, to template gallery 720. Template gallery 720 includes blank template 725, roaming template 723, and suggested template 721. Upon navigating to template gallery 720 using navigation tool 718, mobile device 701 displays template gallery 720. It may be possible to navigate to MRU panel 710 from template gallery 720 using navigation tool 719.

FIGS. 8-11 illustrates various screen shots representative of screen shots rendered by a productivity application, such as Microsoft® Word document editor, the Microsoft® Excel® spreadsheet program, the Microsoft® PowerPoint® presentation program.

In particular, FIG. 8 illustrates screen shot 800 depicting a template gallery available upon launching Microsoft® Word. Screen shot 800 also includes a most recently used panel depicting a list of documents most recently used by a user. Screen shot 800 also includes a personalized welcome message and sign-in prompt function to allow a user to establish an identity, including an identity icon representative of the user. A search box for searching the template gallery or other template stores is also provided. Various template categories or key words are available for selection by the user. The key words may be programmed, or otherwise dynamically determined based on user history, behavior, and the like. The key words allow for quick navigation to a relevant template for a given task.

Indeed, a number and variety of templates are displayed for selection by the user. Upon selecting a template, a document may be launched configured according to the template. Optionally, a preview of the template may be rendered. Note that the user is logged in under an enterprise identity. Thus, at least some of the various templates may be linked to or otherwise associated with the enterprise identity. Similarly, at least some of the documents referenced in the most recently used panel may be associated with the user's enterprise identity.

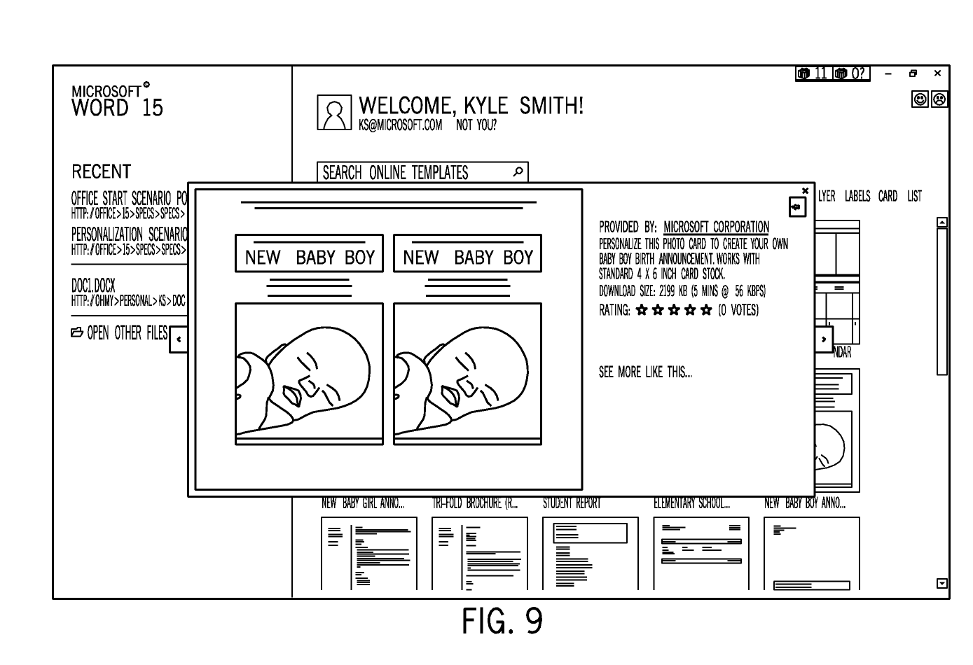

FIG. 9 illustrates screen shot 900, which depicts one such preview of a template. In this example, the preview is of a greeting card template. The user may navigate to additional view of the preview using navigation tabs to either side of the template. Alternatively or optionally, the navigation tabs may be used to navigate to previews of other templates. Which other templates are available for preview using the navigation tabs may be based on their similarity to the template being previewed. For example, if a resume template is being previewed, then the navigation tabs may allow for easy navigation to other resume templates. A template being previewed can be pinned or otherwise designated as a favorite.

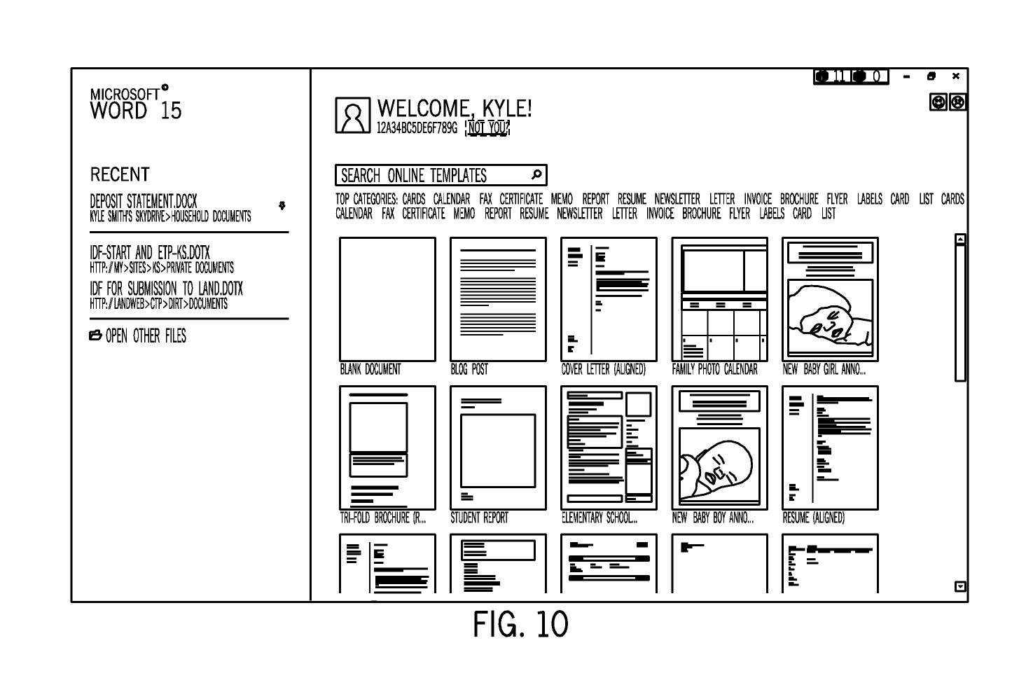

FIG. 10 illustrates screen shot 1000 depicting another template gallery available upon launching Microsoft® Word. While similar to screen shoot 800, note that the user is logged into the productivity application using a personal identity. Thus, at least some of the various templates may be linked to or otherwise associated with the personal identity. Similarly, at least some of the documents referenced in the most recently used panel may be associated with the user's personal identity.

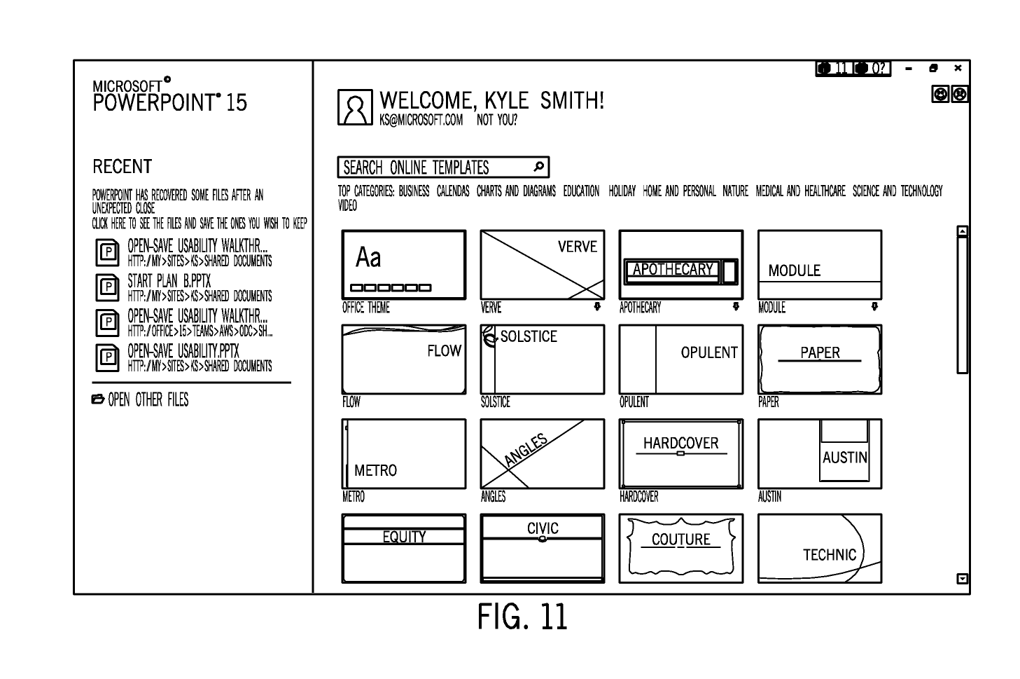

FIG. 11 illustrates screen shot 1100 depicting another template gallery available upon launching a PowerPoint® presentation. Note that the user is logged into the productivity application using an enterprise identity. Thus, at least some of the various templates may be linked to or otherwise associated with the enterprise identity. Similarly, at least some of the documents referenced in the most recently used panel may be associated with the user's enterprise identity.

Many features and functions may be apparent from the foregoing discussion. In particular, template galleries may be enhanced by way of a personal, roaming list of recently accessed files which can be clicked to open that file. A personal list of templates with which a new file can be created may be included in the gallery. The templates may include a blank/basic template, favorite/pinned templates, featured templates, personally recommended templates, personally created templates, and templates provided by an enterprise/organization.

Template galleries may also be enhanced with a search box which will search for templates from an online template repository. A set of suggested or top keywords or categories, possibly server programmed, may also be included. A personalized welcome message, sign in prompt, or other similar user identity function may be provided to allow for switching users, and thus template galleries, within a productivity application.

The personal list of templates with which a new file can be created may include a blank/basic template. The personal list of templates may also include pinned templates, including pre-set pinned items from a server-programmed list (applied when the user has not changed the pinned items by pinning or unpinning to/from the list). A user can pin or unpin templates from the gallery. Templates pinned to this list may be represented as pinned on any computer accessed by the user. Templates pinned to this list can be automatically downloaded in the background to always be available, even offline.

The personal list of templates may also include featured templates. The feature templates may include a set of templates from an online template repository which are programmed via a server-side control. When offline, the featured set may be selected from f templates available on the user's computer.

Personally recommended templates may also be included, such as a set of templates which are chosen from an online template repository based on past user usage of templates. Personally created templates may also be included, such as by way of an additional tab which contains templates created by the user. Templates provided by an enterprise or organization may also be included. Templates provided for the user by an administrator may be defined or identified in a variety of ways, such as by a file path on a hard drive or network share, a custom XML programmed template manifest, a custom XML template web service, or SharePoint® library templates.

If a template is chosen, a preview of the template may be provided. The preview may include aspects such as an auto-slideshow of multiple large visual previews of the template, the ability to see similar templates to the one chosen, and the ability to pin the template to a favorites list.

In a brief operational scenario, a computing device, such as a personal computer, laptop computer, table, mobile phone, smart phone, or some other similar device, may have a productivity application installed or otherwise available thereon. The application may be locally installed, hosted on a remote server and accessed using the computing device, or streamed to the computing device. Regardless, upon launching the application, the application or other application elements executing on the device render a template gallery. In addition, within the template gallery graphical representations of a plurality of templates comprising a graphical representation of a blank template, a graphical representation of a roaming template, and a graphical representation of a suggested template are also rendered.

In an implementation, the graphical representation of the blank template comprises a first image of a blank productivity item, the graphical representation of the roaming template comprises a second image of a roaming productivity item, and the graphical representation of the suggested template comprises a third image of a suggested productivity item. In a variation, the second image of the roaming productivity item comprises a pin representative of a roaming status of the roaming template.

In some examples, the productivity application renders a graphical representation of a search tool within the template gallery and, in response to a query, input via the graphical representation of the search tool, returns search results comprising a first template formatted according to a first file format associated with the productivity application and a second template formatted according to a second file format associated with another productivity application different than the first file format. In some implementations, the first file format comprises at least one of a spreadsheet format, a presentation format, a drawing format, an image format, a database format, and an email format. In some implementations, the second file format comprises at least one of the spreadsheet format, the presentation format, the drawing format, the image format, the database format, and the email format.

Optionally, the productivity application may also render adjacent to the template gallery a graphical representation of a user identity logged into the productivity application. In addition, a most recently used panel may be rendered adjacent to the template gallery, including a plurality of graphical representations of a plurality of productivity items most recently used by a user associated with the user identity logged into the productivity application.

In yet other implementations, the productivity application may render, adjacent to the template gallery, a graphical representation of a first template filter, selection of which filters the graphical representations of the plurality of templates according to the first template filter, and a graphical representation of a second template filter, selection of which filters the graphical representations of the plurality of templates according to the second template filter.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable media having stored thereon program instructions for facilitating templates in a productivity application that, when executed by a computing system, direct the computing system to at least:
identify a plurality of templates for generating productivity items with the productivity application, the plurality of templates comprising a blank template, a roaming template, and a suggested template; and
upon initiating the productivity application, display a plurality of graphical representations of the plurality of templates within a template gallery, the plurality of graphical representations of the plurality of templates comprising a graphical representation of the blank template, a graphical representation of the roaming template, and a graphical representation of the suggested template.

2. The one or more computer readable media of claim 1 wherein the graphical representation of the blank template comprises a first image of a blank productivity item, wherein the graphical representation of the roaming template comprises a second image of a roaming productivity item, and wherein the graphical representation of the suggested template comprises a third image of a suggested productivity item.

3. The one or more computer readable media of claim 2 wherein the second image of the roaming productivity item comprises a pin representative of a roaming status of the roaming template.

4. The one or more computer readable media of claim 1 wherein the program instructions further direct the computing system to display a graphical representation of a search tool within the template gallery and, in response to a query, input via the graphical representation of the search tool, return search results comprising a first template formatted according to a first file format associated with the productivity application and a second template formatted according to a second file format associated with another productivity application different than the first file format.

5. The one or more computer readable media of claim 4 wherein the first file format comprises at least one of a spreadsheet format, a presentation format, a drawing format, an image format, a database format, and an email format and wherein the second file format comprises at least one of the spreadsheet format, the presentation format, the drawing format, the image format, the database format, and the email format.

6. The one or more computer readable media of claim 4 wherein the program instructions, when executed by the computing system, further direct the computing system to display adjacent to the template gallery a graphical representation of a user identity logged into the productivity application.

7. The one or more computer readable media of claim 6 wherein the program instructions further direct the computing system to display, in a most recently used panel adjacent to the template gallery, a plurality of graphical representations of a plurality of content items most recently used by a user associated with the user identity logged into the productivity application.

8. One or more computer readable media having stored thereon program instructions for facilitating templates in a productivity application that, when executed by a computing system, direct the computing system to at least:
render a template gallery upon initiating the productivity application; and
render within the template gallery graphical representations of a plurality of templates comprising a graphical representation of a blank template, a graphical representation of a roaming template, and a graphical representation of a suggested template.

9. The one or more computer readable media of claim 8 wherein the graphical representation of the blank template comprises a first image of a blank productivity item, wherein the graphical representation of the roaming template comprises a second image of a roaming productivity item, and wherein the graphical representation of the suggested template comprises a third image of a suggested productivity item.

10. The one or more computer readable media of claim 9 wherein the second image of the roaming productivity item comprises a pin representative of a roaming status of the roaming template.

11. The one or more computer readable media of claim 8 wherein the program instructions further direct the computing system to render a graphical representation of a search tool within the template gallery and, in response to a query, input via the graphical representation of the search tool, return search results comprising a first template formatted according to a first file format associated with the productivity application and a second template formatted according to a second file format associated with another productivity application different than the first file format.

12. The one or more computer readable media of claim 11 wherein the first file format comprises at least one of a spreadsheet format, a presentation format, a drawing format, an image format, a database format, and an email format and wherein the second file format comprises at least one of the spreadsheet format, the presentation format, the drawing format, the image format, the database format, and the email format.

13. The one or more computer readable media of claim 11 wherein the program instructions, when executed by the computing system, further direct the computing system to render adjacent to the template gallery a graphical representation of a user identity logged into the productivity application.

14. The one or more computer readable media of claim 13 wherein the program instructions further direct the computing system to render, in a most recently used panel adjacent to the template gallery, a plurality of graphical representations of a plurality of productivity items most recently used by a user associated with the user identity logged into the productivity application.

15. The one or more computer readable media of claim 14 wherein the program instructions further direct the computing system to render, adjacent to the template gallery, a graphical representation of a first template filter, selection of which filters the graphical representations of the plurality of templates according to the first template filter, and a graphical representation of a second template filter, selection of which filters the graphical representations of the plurality of templates according to the second template filter.

16. A method for facilitating templates in a productivity application, the method comprising:
initiating rendering of a blank template icon within a template gallery;
initiating rendering of a roaming template icon within the template gallery; and
initiating rendering of a suggested template icon within the template gallery; and
initiating rendering of a preview of a template upon selection of one of at least the blank template icon, the roaming template icon, and the suggested template icon.

17. The method of claim 16 further comprising, in response to launching the productivity application, rendering the template gallery.

18. The method of claim 17 further comprising rendering a search box within the template gallery.

19. The method of claim 18 further comprising rendering a list of most recently used documents adjacent to the template gallery.

20. The method of claim 19 further comprising rendering adjacent to the template gallery an identity icon representative of a user identity logged into the productivity application.
